(19) United States
(12) Patent Application Publication
(10) Pub. No.: US 2013/0195091 A1
(43) Pub. Date: Aug. 1, 2013

(54) WIRELESS BRIDGE DEVICE

(71) Applicants: Richard Gibbs, Woodbury, MN (US); Joseph P. Tretter, III, Minneapolis, MN (US); James A. Meyer, Shoreview, MN (US); Stephen E. Hidem, Plymouth, MN (US); Aaron Michael Fontaine, Fridley, MN (US)

(72) Inventors: Richard Gibbs, Woodbury, MN (US); Joseph P. Tretter, III, Minneapolis, MN (US); James A. Meyer, Shoreview, MN (US); Stephen E. Hidem, Plymouth, MN (US); Aaron Michael Fontaine, Fridley, MN (US)

(73) Assignee: North Pole Engineering, Inc., Minneapolis, MN (US)

(21) Appl. No.: 13/753,010

(22) Filed: Jan. 29, 2013

Related U.S. Application Data
(60) Provisional application No. 61/592,857, filed on Jan. 31, 2012.

(51) Int. Cl. H04W 88/08; H04W 84/12

(52) U.S. Cl. CPC H04W 88/08; H04W 84/12
USPC 370/338

(57) ABSTRACT

Techniques are described for connecting devices that use the ANT wireless protocol to other devices or networks that use the Wi-Fi wireless protocol. In one example, a network device is disclosed that comprises a processor configured to receive ANT data from a sensor, encapsulate the ANT data in a Wi-Fi packet, and transmit the Wi-Fi packet directly to a wireless access point without using an intermediate computing device.

### CROSS REFERENCE TO RELATED APPLICATIONS

This application claims priority from U.S. Application No. 61/592,857, filed on Jan. 31, 2012, the entire contents of which is hereby incorporated by reference.

### TECHNICAL FIELD

The disclosure relates to computer networks and, more particularly, to techniques for connecting devices within a computer network.

### BACKGROUND

Many individuals, including, for example, the elderly, health care patients, and fitness enthusiasts use devices that monitor various body parameters. For example, devices are available to monitor and collect data on heart rates, blood pressure, and blood glucose. In addition, devices are available that attach to fitness equipment, e.g., bicycles, that collect data on speed, distance, cadence, and power, for example. These devices may transmit the collected data wirelessly for analysis.

### SUMMARY

In general, this disclosure describes techniques for connecting devices that use the ANT wireless protocol (or “ANT devices”) to other devices or networks that use the Wi-Fi wireless protocol. More particularly, the techniques described in this disclosure provide a bridge or gateway for ANT devices to communicate through Wi-Fi networks to other devices on the local network or over the Internet.

In one embodiment, this disclosure is directed to a network comprising a processor configured to receive ANT data from a sensor, encapsulate the ANT data in a Wi-Fi packet, and, transmit the Wi-Fi packet directly to a wireless access point without using an intermediate computing device.

In another embodiment, this disclosure is directed to a method comprising receiving ANT data from a sensor, encapsulating the ANT data in a Wi-Fi packet, and transmitting the Wi-Fi packet directly to a wireless access point without using an intermediate computing device.

In another embodiment, this disclosure is directed to a computer-readable medium encoded on the computer-readable medium that, when executed, cause a processor to receive ANT data from a sensor, encapsulate the ANT data in a Wi-Fi packet, and transmit the Wi-Fi packet directly to a wireless access point without using an intermediate computing device.

In another embodiment, this disclosure is directed to a network device comprising a processor configured to receive ANT data from a sensor, encapsulate the ANT data in a Wi-Fi packet, and transmit the Wi-Fi packet to at least two Wi-Fi enabled devices.

In another embodiment, this disclosure is directed to a method comprising receiving ANT data from a sensor, encapsulating the ANT data in a Wi-Fi packet, and transmitting the Wi-Fi packet to at least two Wi-Fi enabled devices.

In another embodiment, this disclosure is directed to a computer-readable storage medium comprising instructions encoded on the computer-readable medium that, when executed, cause a processor to receive ANT data from a sensor, encapsulate the ANT data in a Wi-Fi packet, and transmit the Wi-Fi packet to at least two Wi-Fi enabled devices.

A method comprising receiving a computer-readable instruction set from a user, receiving ANT data from a sensor, processing the ANT data in accordance with the instruction set, encapsulating the ANT data in a Wi-Fi packet, and transmitting the Wi-Fi packet directly to a wireless access point without using an intermediate computing device.

The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network joined using a bridging device that may implement one or more aspects of this disclosure.

FIG. 2 is a block diagram illustrating an example bridging device that may implement one or more aspects of this disclosure.

FIG. 3 is an example interaction diagram for an interaction between a bridge device and a wireless endpoint device, in accordance with one or more aspects of this disclosure.

FIG. 4 is an example of using a whitelist/blacklist to filter data and shows the movement of data between the bridge and the wireless endpoint device.

FIG. 5 is an example interaction diagram for an interaction between a bridge device and an ANT enabled device, in accordance with one or more aspects of this disclosure.

### DETAILED DESCRIPTION

ANT is a proprietary communication protocol of Dynastream Innovations Inc. that is primarily used for collection and transfer of sensor data. For example, individuals may collect and transfer workout data using such ANT enabled devices as heart rate monitors, stride-based speed and distance monitors, bicycle speed and cadence monitors, bicycle power monitor, and the like using an ANT protocol.

This disclosure describes techniques for providing a bridge for ANT devices to communicate through Wi-Fi networks to other devices or over the Internet. These techniques provide a mechanism for connecting ANT devices to an Internet-based service, e.g., a website, without an intermediate computer, for data monitoring and/or data collection purposes. In addition, these techniques provide a mechanism for bridging between multiple ANT nodes in distributed ANT topologies.

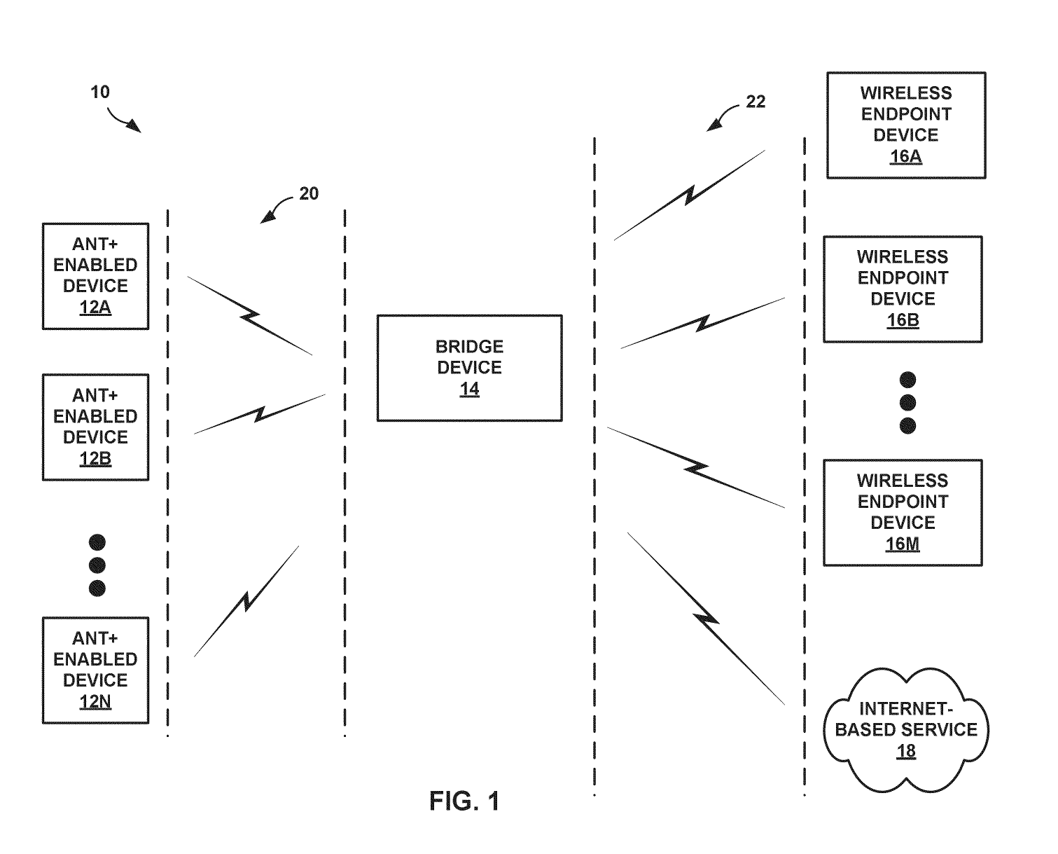

FIG. 1 is a block diagram illustrating an example network joined using a bridging device that may implement one or more aspects of this disclosure. In particular, FIG. 1 depicts an example network, shown generally at 10, that includes a plurality of ANT enabled devices 12A-12N (collectively referred to in this disclosure as “ANT enabled devices 12”), bridge device 14, a plurality of wireless endpoint devices 16A-16M (collectively referred to in this disclosure as “wireless endpoint devices 16”), and one or more Internet-based services 18 and joined together via bridge device 14 using one or more techniques described in this disclosure. An Internet-based service 18 may be a website that collects, analyzes, and displays information derived from the data transmitted by the ANT enabled devices 12. In one example, Internet-based service 18 may be a website that is hosted by the company that markets the ANT enabled device 12A, e.g., a heart rate monitor.

In FIG. 1, ANT enabled devices 12 are connected to a network device, namely bridge device 14, via a respective ANT channel, shown generally at 20. In other words, each of the N ANT enabled devices 12, e.g., heart rate monitors, stride-based speed and distance monitors, bicycle speed and cadence monitors, bicycle power monitor may connect to bridge device 14 via a prescribed ANT RF channel monitored by the bridge device 14 and the particular ANT enabled devices 12. In some example configurations, N is equal to 8. In other example configurations, N is greater than or less than 8.

Wireless endpoint devices 16 (e.g., a smart phone, laptop computer, desktop computer, tablet computer, and the like) and the one or more Internet-based services 18 are connected to bridge device 14 via a respective Wi-Fi connection, shown generally at 22. In other words, each of the M wireless endpoint devices 16, e.g., a laptop computer, desktop computer, a mobile phone, a smart phone, a Personal Digital Assistants (PDA), and the like, may receive data from the bridge device 14 via one of a respective M Wi-Fi connections established by the bridge device 14 sending generated messages. In some example configurations, M can be all devices on the local network. In other example configurations, M is devices on the local network and Internet routable endpoints.

Using the techniques of this disclosure, bridge device 14 may route data from one or more of ANT enabled devices 12 to one or more wireless endpoint devices 16, as will be described in more detail below. For instance, bridge device 14 may route data received from ANT enabled device 12A, e.g., a heart rate monitor, to a plurality of wireless endpoint devices 16A and 16B, e.g., a smart phone and a laptop computer. In other words a single transmission of data from an ANT enabled device can be routed/broadcast substantially simultaneously to multiple wireless endpoint devices 16.

Existing devices are capable of routing data from an ANT enabled device through a bridge device to a dongle that is plugged into an interface on a computer. With these existing devices, data is transmitted from the computer to an Internet-based service. Thus, an intermediate device (a computer) is required to transmit data from the ANT enabled device to the Internet-based service.

Using the techniques of this disclosure, bridge device 14 may route data from one or more ANT enabled devices 12 directly to Internet-based service 18, e.g., a website that is hosted by the company that markets ANT enabled device 12A, without using an intermediary device such as a computer, as will be described in more detail below. Bridge device 14 provides the ability to transfer data from ANT enabled devices 12 to a website without the need to have a computing device as an intermediary. In other words, bridge device 14 can push ANT data from one or more ANT enabled devices 12 directly to a website without the need or expense of a separate computer.

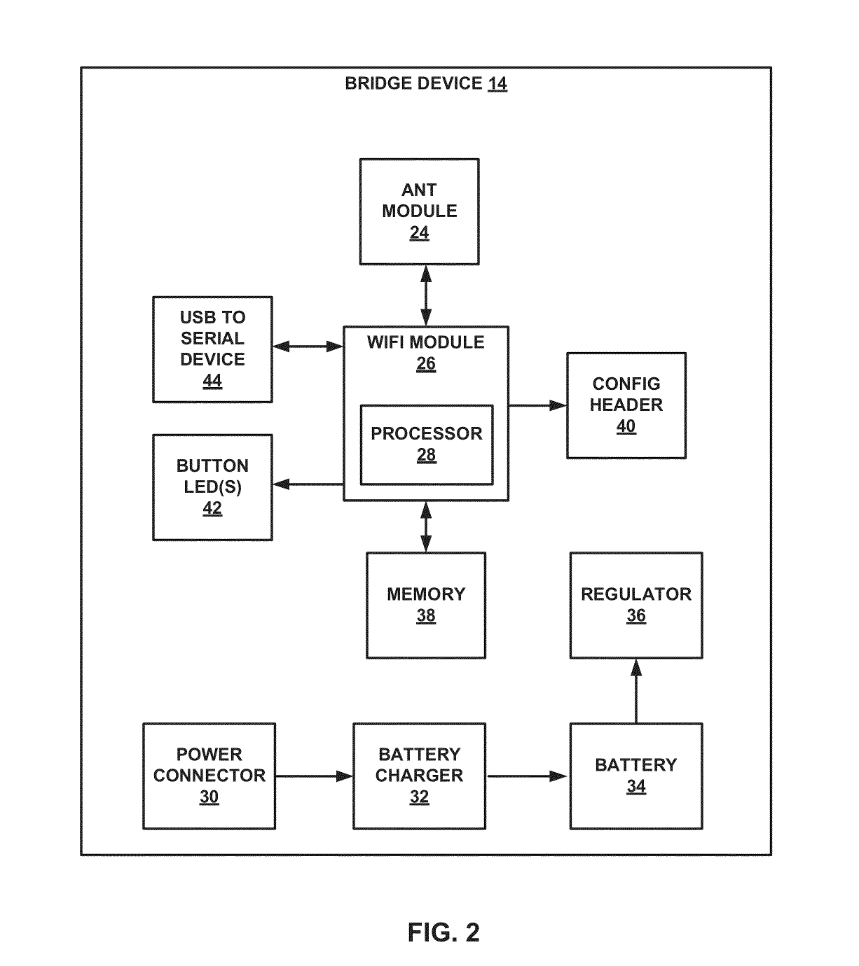

FIG. 2 is a block diagram illustrating an example bridge device that may implement one or more aspects of this disclosure. The example bridge device 14 of FIG. 2 includes ANT module 24 and Wi-Fi module 26. ANT module 24 includes a radiofrequency (RF) transceiver (not depicted) that is connected to an antenna (not depicted) and controlled by an ANT protocol engine (not depicted) that is configured to implement, among other things, an ANT communication protocol. ANT module 24 establishes communication channel(s) between bridge device 14 and one or more ANT enabled devices 12, and, once established, receives ANT data from ANT enabled devices 12.

Wi-Fi module 26 includes a wireless subsystem (not depicted) that includes a wireless RF transceiver that is connected to an antenna and is compatible with, for example, IEEE 802.11 b/g/n wireless standards. Wi-Fi module 26 further includes a memory subsystem (not depicted), e.g., FLASH memory that may store firmware, for example. In addition, Wi-Fi module 26 includes processor 28 that is configured to execute instructions stored, for example, in computer-readable storage media, e.g., in the memory subsystem and that implement various techniques described in this disclosure. It should be noted that the functions attributed to processor 28 in this disclosure may be embodied as hardware, software, firmware, as well as combinations of hardware, software, and firmware. Processor 28 may, in some examples, include non-volatile memory for storing computer-readable instructions and data.

Wi-Fi module 26 receives ANT data from ANT module 24, encapsulates the ANT data into a Wi-Fi packet and, in particular, the payload of the Wi-Fi packet, and then transmits the packet to one or more wireless endpoint devices 16 or Internet-based service 18. In some examples, bridge device 14 may establish a secure connection to Internet-based service 18 using, for example, Hypertext Transfer Protocol Secure (HTTPS). Upon receiving the Wi-Fi packet, the one or more wireless endpoint devices 16 de-encapsulate the Wi-Fi packet and use the ANT data as specified by a particular application that is being executed on the wireless endpoint device or Internet-based service 18.

Bridge device 14 further includes power connector 30, e.g., mini-Universal Serial Bus (USB) connector, micro-USB connector, a non-USB connector, or some other connector, that provides power to battery charger circuit 32 for charging battery 34. Battery 34 provides power to Wi-Fi module 26. Regulator 36 supplies a regulated voltage to various components of bridge device 14, including ANT module 24.

In some example configurations, bridge device 14 includes memory 38. Wi-Fi module 26 is in communication with memory 38, which in some example configurations may be FLASH memory. Memory 38 may be used, for example, to temporarily store data received from one or more ANT enabled devices 12.

Bridge device 14 further includes configuration header module 40, which adds a packet protocol header to all Wi-Fi packets. The header, for example, identifies the type of packet and/or the command being issued by bridge device 14. Bridge device 14 also includes light emitting diode(s) (LEDs) 42 that allow a user to visually identify a particular bridge device 14 among several available bridge devices 14, as will be described in more detail below.

In some example implementations, bridge device 14 further includes USB to serial device 44. USB to serial device 44 allows a user to connect bridge device 14 to an external computer via a cable and program Wi-Fi module 26, thereby allowing the user, e.g., a software developer, to reconfigure bridge device 14 to execute applications developed by the user. In this manner, bridge device 14 receives a computer-readable instruction set from the user that is capable of being implemented by processor 28. Bridge device 14 is thus a programmable bridge platform and not simply an end consumer product. That is, bridge device 14 is a configurable product that an entity can develop, via a development platform, bridge applications on top of the existing base functionality of bridge device 14. Bridge device 14 may receive ANT data from a sensor, processor the ANT data in accordance with the instruction set, encapsulate the ANT data in a Wi-Fi packet, and transmit the Wi-Fi packet directly to a wireless access point without using an intermediate computing device.

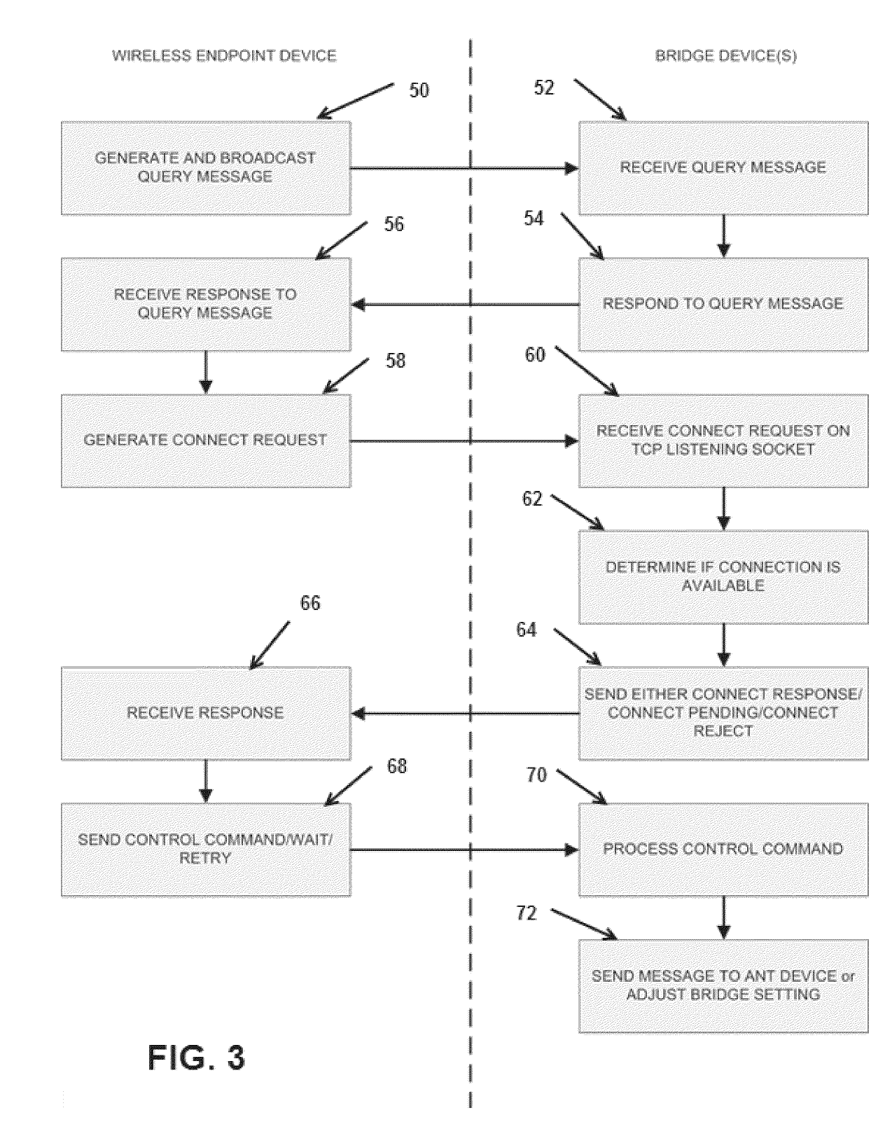

FIG. 3 is an example interaction diagram for an interaction between a bridge device and a wireless endpoint device, in accordance with one or more aspects of this disclosure. In the non-limiting example of FIG. 3, which is provided for purposes of illustration only, wireless endpoint device 16 generates and transmits a query message (50). The query message is broadcast to all bridge devices 14 on the Wi-Fi network as part of a discovery process.

Upon receiving the query message (52), each bridge device 14 and, in particular, processor 28 generates a response that may include, for example, the name of the bridge device, the list of endpoint addresses, and the media access control (MAC) address of the bridge device (54). The wireless endpoint device receives the response from bridge device 14 (56), and uses the information received to interpret the sensor data received from the bridge device 14 and generate a connect request (58). The IP binding table maps the wireless communication channels between a particular bridge device 14 and each wireless endpoint device that is discovered via a discovery process. The IP binding table allows bridge device 14 to keep track of each wireless endpoint device to which a communication channel is (later) established. In other words, each channel of bridge device 14 knows which wireless endpoint device to pass data to because of the information stored in the IP binding table. Each channel of bridge device 14, e.g., each of 8 channels, can send to however many wireless endpoint devices are stored in the IP binding table, e.g., 16 endpoint devices, up to the maximum number supported by bridge device 14.

There are two entries in the IP binding table used for forwarding encapsulated ANT messages. These two entries can be used in one of two ways. First, UDP messages can be routed to a specific IP address/Port on either the local network or a routable Internet destination. Second, UDP messages can be published to a Multicast Address/Port on the local network. Any device on the local network can subscribe to the Multicast Address/Port and receive the broadcast data. This method greatly enhances the number of endpoints that can simultaneously receive data. Additionally, a Wi-Fi endpoint can receive from multiple bridges on the local network simultaneously. The Multicast protocol allows any number of bridge devices to publish data on the same Address/Port combination. A third IP address stored in the IP binding table is used for TCP socket communications to a specific IP Address/Port end point. This connection is used primarily for ANT-FS file transfer operations the need to guarantee transmission of the data. This connection could be used for normal broadcast data, but this is not typical.

A fourth type of connection is a TCP connection used for configuration and control of the bridge device. This TCP socket connection is established by the Wi-Fi device opening a socket connection with the bridge device. The bridge device has previously setup a TCP listening socket for the Wi-Fi device connection. Only one device is allowed to connect for communication and control. A second device can establish a pending connection to let the connected device know there is another device wanting the socket. The connected device can decide to give up the connection or kick the device off the pending connection. If the both types of connections are occupied, any subsequent device requesting connection are rejected.

The IP binding table may be stored in memory in of processor 28 of Wi-Fi module 26 of bridge device 14 (FIG. 2) or in a memory device in communication with Wi-Fi module 26, e.g., memory 38 of FIG. 2). It should be noted that the querying endpoint device 16 receives and stores the IP address of each bridge device 14 that responds to the query. In some example implementations, an IP address, e.g., of Internet-based service 18, may be preconfigured on bridge device 14. For example, a particular manufacturer of a wireless endpoint device 16 may preconfigure bridge device 14 with an IP address of the manufacturer's website, e.g., stored in non-volatile memory of bridge device 14, so that any data received by the bridge device is sent directly to the website. Upon receiving the generate connect request on the TCP listening socket (60) from the endpoint device, e.g., a smart phone, each bridge device 14 and, in particular, processor 28, determines whether any Wi-Fi connections are available (62). That is, at the time of the request, bridge device 14 may have already established the maximum number of connections between various other endpoint devices and, as such, does not have the capacity to establish another connection. Processor 28 generates and sends a response to wireless endpoint device 16 that indicates whether any connections are available (connect response / connect pending / connect reject) (64). Wireless endpoint device 16 receives the response to the generate connect request from bridge devices 14 and, based on the received response as well as the wireless signal strength of bridge devices 14, wireless endpoint device 16 sends a control command if the endpoint device received a connect response, or waits if it received a connect pending response or retries if it received a connect reject response (68).

In response, the ANT enabled device generates and sends a response to bridge device 14, thereby registering the ANT enabled device 12 with bridge device 14 such that whenever the ANT enabled device 12 receives data, the ANT enabled device 12 sends the data to bridge device 14 and, in turn, bridge device 14 sends the data to endpoint device 16. In this manner, bridge device 14 establishes a connection between the endpoint device and an ANT enabled device 12 (72). The process described above essentially creates a virtual wire between the endpoint device and an ANT enabled device 12 through bridge device 14 that allows ANT data to flow from an ANT enabled device to one or more wireless endpoint devices 16 and/or to one or more Internet-based services 18, as will be described in more detail below.

Once connections between bridge device 14 and one or more ANT enabled device are established, as described above, the wireless endpoint device, e.g., a smart phone, laptop computer, desktop computer, tablet computer, and the like, can receive incoming data from any connected channel. For example, assume that network 10 (FIG. 1) includes four ANT enabled devices 12 that are each connected via one bridge device 14 to one wireless endpoint device 16. Wireless endpoint device 16 may receive data from each of the four ANT enabled devices 12.

In another example, wireless endpoint device 16 may impose restrictions so that it receives data from only some of the ANT enabled devices 12 connected to bridge device 14. For instance, endpoint device 16 may want to receive data from only two of four ANT enabled devices 12 connected to bridge device 14. In such an example, each of the four ANT enabled devices 12 continue to send data to bridge device 14, but processor 28 of bridge device 14 drops data from the two unwanted ANT enabled devices 12, and processor 28 generates and forwards Wi-Fi packets containing the data from only the two selected ANT enabled devices 12.

As indicated above, multiple wireless endpoint devices 16 e.g., four wireless endpoint devices 16, may be connected to bridge device 14. In such a configuration, each connected wireless endpoint device 16 may impose restrictions so that it receives data from only some of the connected ANT enabled devices 12, e.g., eight connected ANT enabled devices 12.

For example, endpoint device 16A and endpoint device 16B may want to receive data from all available channels, e.g., ANT enabled devices 12A-12H, endpoint device 16C may want to receive data from only ANT enabled devices on channels 1 to 4, e.g., ANT enabled devices 12A-12D, and endpoint device 16D may want to receive data from only ANT enabled devices on channels 5 to 8, e.g., ANT enabled devices 12E-12H. As an example with respect to data received on channel 5 from ANT enabled device 12E, processor 28 of bridge device 14 generates three packets: a first Wi-Fi packet that bridge device 14 transmits to ANT enabled device 12A, a second Wi-Fi packet that bridge device 14 transmits to ANT enabled device 12B, and a third Wi-Fi packet that bridge device 14 transmits to ANT enabled devices 12D. Processor 28 of bridge device 14 will not generate a Wi-Fi packet for ANT enabled device 12C because ANT enabled device 12C only wanted data from ANT enabled devices 12 on channels 1-4. In this manner, bridge device 14 provides routing functionality between a plurality of ANT enabled devices 12 and a plurality of endpoint devices 16.

This is done using a WhiteList/BlackList. Any of the connections in the IP binding table may have a WhiteList/BlackList option. The WhiteList/BlackList filters data by both device type and device ID. The WhiteList and BlackList can be used in conjunction with each other. The WhiteList defines the device type(s)/device ID(s) that are allowed to propagate through the bridge. The BlackList defines the device type(s)/device ID(s) that are blocked by the bridge for a particular entry in the IP binding table. For example if the system only want to monitor two types of ANT devices these two device types would be loaded into the White list. In addition, if there are three particular devices (for example) that should be ignored, the Device IDs for these devices would be added to the BlackList. This can help reduce the amount of traffic sent via the Wi-Fi network.

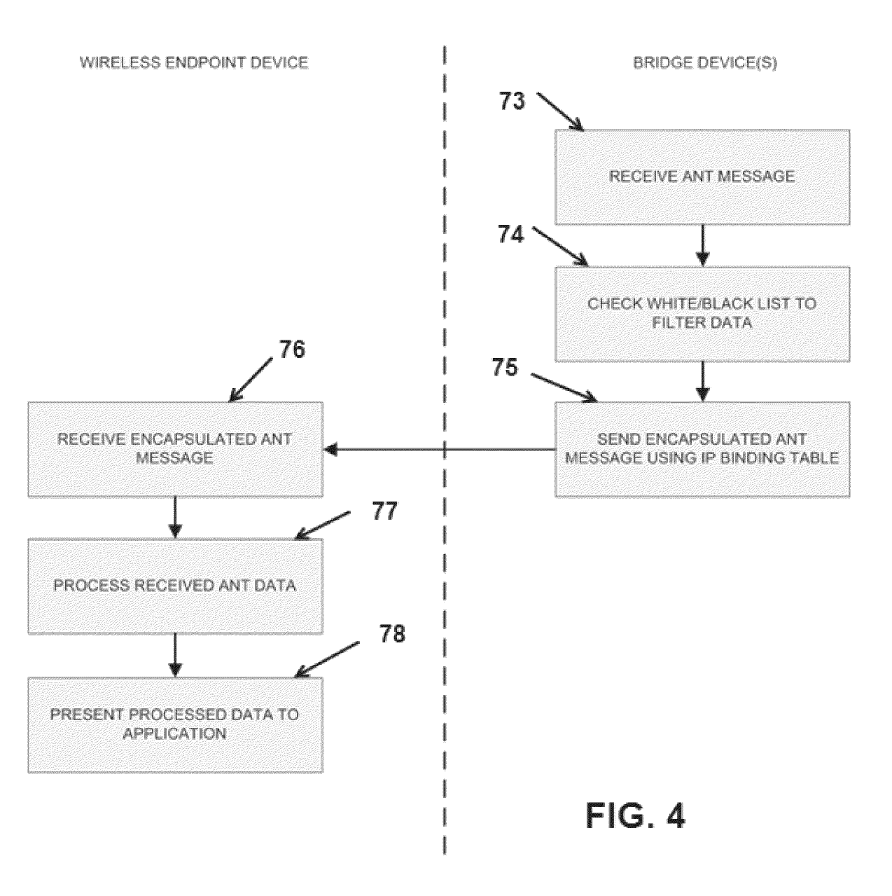

FIG. 4 shows an example of how the whitelist/blacklist allows the movement of data from the bridge 14 to an ANT enabled device 12. In FIG. 4, once the bridge device receives an ANT message (73), processor 28 checks the white/black list to filter data (74). If the data is not filtered out, the bridge device 14 sends an encapsulated ANT message using the IP binding table to the endpoint device 16 (75). The wireless endpoint device receives the encapsulated ANT message (76), processes the received ANT data (77) and presents the processed data to the application (78).

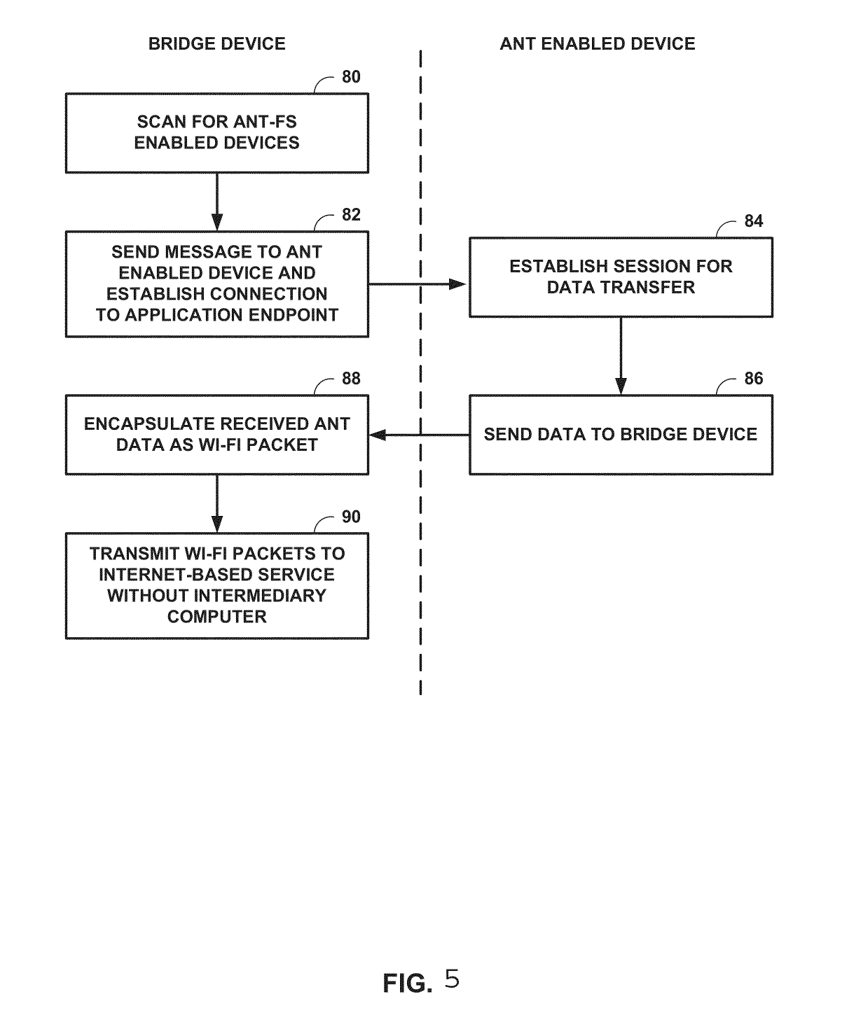

As indicated above, the various techniques of this disclosure provide a mechanism for connecting ANT devices to an Internet-based service, e.g., a website, without an intermediate computer, for data monitoring and/or data collection purposes. These techniques are described in more detail below with respect to FIG. 5.

FIG. 5 is an example interaction diagram for an interaction between a bridge device and an ANT enabled device, in accordance with one or more aspects of this disclosure. More particularly, FIG. 4 depicts an example interaction between a bridge device an ANT enabled device that is executing a file sharing (FS) utility, or ANT-FS enabled device. In the non-limiting example of FIG. 5, which is provided for purposes of illustration only, processor 28 of bridge device 14, via a dedicated channel, scans for ANT-FS enabled devices (80) within range. If an ANT-FS enabled device, e.g., data collection device, is discovered via the scan, processor 28 of bridge device 14 generates and sends a message to the ANT-FS enabled device requesting that ANT-FS enabled device put itself into a file sharing mode (82). Example ANT-FS enabled data collection devices include, but are not limited to, weight scales, blood pressure cuffs, pulse oximeters, blood glucose monitors, fitness watches, and the like. In addition, processor 28 of bridge device 14 establishes a connection to a Wi-Fi application endpoint running on a connected Wi-Fi socket. In one example, the Wi-Fi application endpoint may be, for example, an Internet-based service such as a website with an address that was preconfigured in the ANT-FS enabled device (82), e.g., in the IP binding table. In such an example, bridge device 14 detects a wireless endpoint device 16, requests to link with it. Once linked, bridge device 14 opens a connection to the Internet-based service and bridge device 14 completes its authentication process. In another example, the Wi-Fi application is running on a personal computer, smart phone, or the like. The ANT-FS enabled device 12 establishes a file sharing session for transferring data to bridge device 14 (84).

Processor 28 of bridge device 14 queries the ANT-FS enabled device for files and, if there are any files, the ANT-FS enabled device sends the files to bridge device 14 (86). Processor 28 of bridge device 14 encapsulates the ANT data from the ANT-FS enabled device in a Wi-Fi packet (88) and transmits the Wi-Fi packet directly to a wireless access point that is connected to the Internet via a router, for example. In other words, bridge device 14 transmits the Wi-Fi packet out to the Internet and to the Internet-based service without using an intermediary local computer that is connected to the Internet (90), thereby eliminating the need for a computer. Bridge device 14 then disconnects from ANT-FS enabled device 12 and ANT enabled device 12 returns to a low power state until another data transfer is requested. It should be noted that in some examples, bridge device 14 may establish a secure connection to the Internet-based service using, for example, Hypertext Transfer Protocol Secure (HTTPS).

Transmitting the Wi-Fi packet directly to a wireless access point that is connected to the Internet, as described above, is in contrast to existing techniques and devices. As mentioned above, existing devices are capable of routing data from an ANT enabled device through a bridge device to a dongle that is plugged into an interface on a computer. With these existing devices, data is transmitted from the computer to an Internet-based service. Thus, an intermediate device (a computer) is required to transmit data from the ANT enabled device to the Internet-based service. The techniques of this disclosure are advantageous because a user no longer needs to have a computer to upload data, e.g., fitness data, stored on an ANT enabled device to an Internet-based service. The bridge device described in this disclosure is able to pull data from the ANT enabled device and push it directly to the Internet-based service via a wireless access point without an intermediate computer, e.g., laptop computer, desktop computer, tablet computer, or the like.

In one example, bridge device 14 may be configured by a user via a wireless connection. That is, a user may configure bridge device 14 without using a cable plugged into a computing device.

In another example, bridge device 14 may be configured by a user via a cable. That is, a user may configure bridge device 14 using a cable, e.g., mini-USB, micro-USB, a non-USB cable, or any other type of cable, plugged into a computing device.

Referring again to FIG. 1, only one bridge device 14 is depicted. However, in some example configurations, network 10 may include two or more bridge devices 14. Using the techniques of this disclosure, each bridge device 14 is configured to provide a visual indication, via button LEDs 42 (FIG. 2), to the user that indicates whether a connection, or pairing, exists between devices.

For instance, assume that a user with an ANT enabled device 12, e.g., a heart rate monitor, enters a bicycle spin class with 30 bicycles, where each bicycle is associated with one bridge device 14. The user will associate the ANT enabled device 12 with the bridge device 14 of the particular bicycle that the user selected for the workout because the user only wants one bridge device 14 receiving data from the ANT enabled device. Each bridge device 14 may be preconfigured with an identifier (ID). Using a device, for example, a smart phone, the user may query which bridge devices 14 are available for connection and, using one of the IDs of the bridge devices that are displayed on the smart phone, select a particular bridge device 14 for pairing with the ANT enabled device. In one example, the selected bridge device and, in particular, processor 28 (FIG. 2) instructs button LED(s) 42 to flash to indicate that the bridge device has been selected.

Next, the user pairs the ANT enabled device with the selected bridge device 14. In particular, the user moves the ANT enabled device in close proximity to the selected bridge device 14 and the ANT enabled device automatically pairs with the selected bridge device 14. In accordance with this disclosure, the selected bridge device 14 and, in particular, processor 28 instructs button LED(s) 42 to flash to indicate that the ANT enabled device is paired with the bridge device.

In another example implementation, bridge device 14 may receive data from a number, e.g., 150 or more, of ANT enabled devices, and forward the data to Internet-based service 18, for example, for large scale data capture and processing. Continuing the bicycle spin class example above, a single bridge device 14 may receive data from each user in the class and forward the data to a website, e.g., a website operated by the manufacturer of the bicycles, for collection and processing.

In addition, and in accordance with this disclosure, bridge device 14 may also act as a network interface card (NIC) in order to route packets to a user's web browser. For example, a user may attempt to connect with a Wi-Fi hotspot access point using bridge device 14. Often, Wi-Fi hotspot access points require authentication, e.g., a password entered by the user, in order to join the network. Bridge device 14 does not include a display device or a keypad for entering a password. Using various techniques of this disclosure, bridge device 14 routes packets to a web browser of a computing device connected to bridge device 14, e.g., via a micro-USB cable, thereby allowing the user to authenticate the device and gain access to the network. In this manner, the number of access points available to bridge device 14 is increased.

Various aspects of the disclosure have been described. These and other aspects are within the scope of the following claims.

1. A network device comprising a processor configured to:
receive ANT data from a sensor;
encapsulate the ANT data in a Wi-Fi packet; and
transmit the Wi-Fi packet directly to a wireless access point without using an intermediate computing device.

2. The network device of claim 1 wherein the ANT data is routed to a web service via the wireless access point.

3. The network device of claim 1 wherein the Wi-Fi packet with encapsulated ANT data is broadcast to a plurality of wireless endpoint devices.

4. The network device of claim 1 wherein the sensor is selected from the group consisting of heart rate monitors, stride-based speed and distance monitors, bicycle speed and cadence monitors, bicycle power monitors, and any combination of ANT radio enabled devices.

5. A method comprising:
receiving ANT data from a sensor;
encapsulating the ANT data in a Wi-Fi packet; and
transmitting the Wi-Fi packet directly to a wireless access point without using an intermediate computing device.

6. The method of claim 5 wherein the ANT data is routed to a web service via the wireless access point.

7. The method of claim 5 wherein the Wi-Fi packet with encapsulated ANT data is broadcast to a plurality of wireless endpoint devices.

8. The method of claim 5 wherein the sensor is selected from the group consisting of heart rate monitors, stride-based speed and distance monitors, bicycle speed and cadence monitors, bicycle power monitors, and any combination of ANT radio enabled devices.

9. A network device comprising a processor configured to:
receive ANT data from a sensor;
encapsulate the ANT data in a Wi-Fi packet; and
transmit the Wi-Fi packet to at least two Wi-Fi enabled devices.

10. The network device of claim 9 wherein the ANT data is routed to a web service via the wireless access point.

11. The network device of claim 9 wherein the Wi-Fi packet with encapsulated ANT data is broadcast to a plurality of wireless endpoint devices.

12. The network device of claim 9 wherein the sensor is selected from the group consisting of heart rate monitors, stride-based speed and distance monitors, bicycle speed and cadence monitors, bicycle power monitors, and any combination of ANT radio enabled devices.

13. A method comprising:
receiving ANT data from a sensor;
encapsulating the ANT data in a Wi-Fi packet; and
transmitting the Wi-Fi packet to at least two Wi-Fi enabled devices.

14. The method of claim 13 wherein the ANT data is routed to a web service via the wireless access point.

15. The method of claim 13 wherein the Wi-Fi packet with encapsulated ANT data is broadcast to a plurality of wireless endpoint devices.

16. The method of claim 13 wherein the sensor is selected from the group consisting of heart rate monitors, stride-based speed and distance monitors, bicycle speed and cadence monitors, bicycle power monitors, and any combination of ANT radio enabled devices.

17. A method comprising:
receiving a computer-readable instruction set from a user;
receiving ANT data from a sensor;
processing the ANT data in accordance with the instruction set;
encapsulating the ANT data in a Wi-Fi packet; and
transmitting the Wi-Fi packet directly to a wireless access point without using an intermediate computing device.

18. The method of claim 17 wherein the ANT data is routed to a web service via the wireless access point.

19. The method of claim 17 wherein the Wi-Fi packet with encapsulated ANT data is broadcast to a plurality of wireless endpoint devices.

20. The method of claim 17 wherein the sensor is selected from the group consisting of heart rate monitors, stride-based speed and distance monitors, bicycle speed and cadence monitors, bicycle power monitors, and any combination of ANT radio enabled devices.
